(19) United States
(12) Patent Application Publication
(10) Pub. No.: US 2002/0148737 A1
(43) Pub. Date: Oct. 17, 2002

(54) Bridge element for an electrode

(76) Inventor: Dieter Haaf, Neckarbischofsheim (DE)

Correspondence Address: KRIEGSMAN & KRIEGSMAN, 665 FRANKLIN STREET, FRAMINGHAM, MA, 01702, US

(21) Appl. No.: 10/163,279

(22) Filed: Jun. 5, 2002

Related U.S. Application Data
(63) Continuation of application No. 09/182,165, filed on Oct. 29, 1998.
(60) Provisional application No. 60/065,555, filed on Nov. 14, 1997.

(30) Foreign Application Priority Data
Oct. 30, 1997 (DE) 197 48 052.7

(51) Int. Cl. G01N 27/26

(52) U.S. Cl. 205/775; 204/400; 204/435

(57) ABSTRACT

The present invention concerns a bridge substance for an electrode for measuring electrochemical values, particularly for measurement of the ion activity of a sample. The bridge substance comprises a solid, electrically conducting, chemically inert material including a ceramic doped with salts, a glass doped with salts, or of a mixture thereof. The invention further concerns an electrode having such a bridge substance. The present bridge substance allows the measurement of electrochemical values in highly alkaline samples and of samples containing organic solvents. The electrode according to the invention is also suitable for miniaturization.

### BACKGROUND OF THE INVENTION

1. Field of the Invention

The invention concerns 1) a bridge substance for an electrode for measuring electrochemical values, particularly for measurement of ion activity of a sample, comprised of a solid, electrically conducting, chemically inert material, and 2) an electrode comprising a bridge substance.

2. Description of Related Art

A polymeric bridge material is described in German Utility Model G 90 17 038. This material is essentially comprised of a polymer which is doped with ions dissolved in an organic solvent.

A bridge substance and an electrode of this type are further known from DE 4,329,742 A1. This electrode is comprised of a solid metal electrode unit, which is coated with a thin conducting layer of a salt of the metal of the electrode unit. A bridge substance is provided as the outermost layer. A compensation layer can be provided between the bridge substance and the electrode unit or the metal salt. The bridge substance in this patent is prepared from a plastic doped with salts. Plastics used for this purpose are epoxy resins and polyvinyl esters. One problem with this known electrode is that it is not suitable for measurements in the highly alkaline range and in the presence of organic solvents, such as acetone, because plastics are chemically degraded in these regimes.

Electrodes having a diaphragm are known, which can be used in the highly alkaline range or in the presence of organic solvents. These electrodes, however, have the disadvantage that the samples or sample liquid can penetrate the diaphragm and reach the inside of the electrode. The electrolyte inside the electrode is consequently adulterated. Furthermore, the pore openings of the diaphragm can become clogged. Such electrodes are thus very maintenance-intensive and become increasingly imprecise in the highly alkaline range.

### SUMMARY OF THE INVENTION

The present invention comprises a bridge substance suitable particularly for measurements in the highly alkaline range or in the presence of organic solvents. The bridge substance comprises a principal compound, which is resistant to alkali and organic solvents, that is doped with salts. The principal compound preferably comprises a ceramic or glass. The invention further comprises an electrode comprising the bridge substance.

The bridge substance and the electrode according to the invention preferably comprise doped glass, doped ceramics or a mixture thereof. The glass-ceramic mixtures are hereafter referred to as “glass ceramics.” In a preferred embodiment, the bridge substance comprises a glass ceramic. In another preferred embodiment, the bridge substance of the invention comprises a doped ceramic having a doped glass coating. This structure may be used as a reference electrode, a measurement electrode, or both, so that a symmetrical measurement chain can be produced in a particularly advantageous manner. Such a symmetrical measurement chain facilitates temperature compensation.

Ceramics doped with salts, glasses doped with salts or mixtures thereof are surprisingly excellent bridge substances. The reference electrodes that can be produced using the present bridge substance are suitable for measurements in highly alkaline media and in the presence of organic solvents such as acetone. For example, they may be used for measuring aquous lacquer suspensions containing solvent fractions.

Dopant salts which can be used in the present invention include potassium, sodium, lithium, tetraethylammonium chloride, neutral salts, and mixtures thereof. In a preferred embodiment, a mixture of potassium and sodium chloride is used. However, other salts or salt mixtures, whose ions, in their totality, have substantially the same mobility and the same transport number of anions and cations, may be used. In a currently preferred embodiment, the dopant mixture comprises potassium and sodium chloride in a ratio of approximately 2:1. A person skilled in the art may make adjustments to the mixing ratio to suit the field of application.

Any ceramic material may be used as the principal compound in the present invention. Metal oxide ceramics are particularly suitable for the bridge substance, including aluminum, magnesium, manganese, and beryllium oxide.ceramics. Casting ceramics, which are mixed with water, can also be used. The ceramic material is then doped with salts, prehardened, and then hardened by heating. Powder ceramics may also be used which are mixed with salts and are melted or sintered. For example, powder ceramics, as used in dental technology, are suitable. In this case, it is preferable that the salts be added to a concentration of approximately 5 to 30% by weight. In the case of casting ceramics, approximately 0.5 to 3 moles/liter of salts are dissolved in water and approximately 1 liter of this solution is mixed with approximately 4 kg of powder. There results a fraction of salts of approximately 20% by weight.

Instead of ceramics, the bridge substance of the invention may also comprise a glass, generally of a silicon dioxide structure. Particularly suitable is lead-cadmium glass, since this material has a particularly smooth surface and is characterized by a relatively low melting point, at which the salts added according to the invention do not evaporate during the production process (sintering, melting, etc.). Glasses which contain oxides or hydroxides of titanium, actinides and/or lanthanides have comparable properties and also are suitable. For example, porcelain enamel powder can be used. The powder is mixed with the salts and melted onto the already sintered bridge substance on the side contacting the sample or added to the bridge substance prior to sintering.

The bridge substance also may comprise a polymer or a mixture of polymers having ions dissolved in an organic solvent. The polymer can be any alkali and organic solvent resistant polymer or polymer blend, for example, a duroplast such as a polyester resin or an epoxy resin, or a non-halogenated or halogenated thermoplast such as polyethylene, polypropylene, polyvinyl chloride, or polytetrafluoroethylene. The polymer is doped with a salt dissolved or suspended in an organic solvent, for example, lithium or tetraethylammonium chloride dissolved or suspended in methanol, ethanol, or isopropanol. For reference electrodes, it is important that the cation and anion charge magnitudes be substantially equal.

In one embodiment, hygroscopic salts, such as lithium salts, may be added to keep the material of the bridge substance slightly moist. This measure reduces the amount of time required to condition in water the electrode according to the invention. Without hygroscopic salts, conditioning times range from approximately 5 minutes at 130° C. to approximately 30 minutes at room temperature. If, however, the electrode according to the invention contains hygroscopic salts, only a few minutes (e.g., less than 30 minutes) at room temperature are required.

In another embodiment, fluoride salts may be added to increase the acid stability of the bridge substance. Lithium salts and fluoride salts are preferably added to a concentration of approximately 5% by wt. of the potassium chloride/sodium chloride mixture.

The bridge substance according to the invention can be used in several types of electrodes. In the case of measurement electrodes, the material of the bridge substance in contact with the sample reacts in an ion-selective manner. In reference electrodes, it is chemically inert. The electrode unit preferably comprises a solid metal, silver or mercury for example, coated with a thin layer of a salt or salts of the metal, silver chloride for example, and is in contact with a reference electrolyte. Use of the present bridge materials in reference electrodes (i.e., in electrodes having potentials independent of the sample) is particularly advantageous. The present bridge substance also can be used in an ion-selective electrode. Use of the present bridge substance in both electrodes yields a symmetric measurement chain and results in facilitated temperature compensation. Also, the breaking strength of the electrode according to the invention is expected to be greater than the strength of those of the prior art. In these embodiments, the bridge substance serves as the carrier for ion-selective materials such as ion-selective glass. Substances that may be advantageously melted onto the bridge for fluoride, chloride, and iodide determinations are pH-membrane glass or lanthanum fluoride (e.g., a monocrystal doped with europium), silver chloride, and silver iodide, respectively. In this example, the phase boundaries of such electrodes are as follows:

Reference electrode: Metal//metal salt//dissolved anion and cation//bridge substance//sample

Measurement electrode: Metal//metal salt//dissolved anion and cation//bridge substance//ion-sensitive material//sample

Of course, the bridge substance itself may also be doped with ion-sensitive material.

The use of the present bridge substance in a reference electrode together with conventional glass electrodes as a sensor in a measurement chain is particularly advantageous. The bridge substance according to the invention may also be utilized with conventional bypass (shunt) electrodes. A reference electrode according to the invention can be expanded in the above described manner to an ion-selective electrode, so that symmetric measurement chains are possible with a reference electrode according to the invention and an ion-selective electrode according to the invention.

Another advantageous embodiment of the second type of electrode is obtained if a filling with a salt solution, particularly with 3-molar potassium chloride solution, is provided between the electrode unit or the thin layer of metal salt and the bridge substance. This corresponds to the conventional reference electrode for ion activity measurement (e.g., pH measurement), whereby the conventional diaphragm is replaced by the bridge substance according to the invention.

Electrodes comprising the bridge substance according to the invention are well suited as reference electrodes since ceramics and glass have small porosities. The reference electrolyte is unlikely to be contaminated because it does not come into contact with the measurement solution, and the capillaries cannot become clogged as occurs with the use of some diaphragms.

The bridge substance according to the invention has a great advantage in that it can be used to produce miniaturized electrodes. In one embodiment, the individual components in the sequence electrode unit, intermediate layer, and reference unit are attached to a transistor. It is particularly advantageous to attach the bridge substance according to the invention to a transistor by means of a polymer or a polymer mixture. These polymers have ions dissolved in organic solvents. This is particularly suitable with bridge substances having metal oxide ceramics.

The electrodes produced with the bridge substance according to the invention can be utilized in two-bar measurement chains and one-bar measurement chains, each with or without a two-channel impedance transformation. They may be combined at will with conventional electrodes. The bridge substance according to the invention may have a particularly high input resistance, for example, more than 5 kΩ. The reference electrode, as well as the measurement electrode, can be treated in a high-ohm manner by a particular configuration of the circuit. In conventional circuits, the low-ohm (less than 5 kΩ according to DIN or German Industrial Standards 19260 to 19268) reference potential is practically ground potential. A special circuit with high-ohm treatment of the measurement and reference electrodes is then recommended, if the throughput resistance of the reference electrode is greater than 5 kΩ.

A circuit herein used as an example is essentially the same as described in DE 4,329,742 A1; therefore, reference is made to this publication in order to avoid repetition, and the disclosure with respect to the measurement arrangement described therein that is also applicable with the present invention is fully incorporated herein by reference.

It is also possible to configure the throughput resistance of the electrode according to the invention as a reference electrode to below 5 kΩ, in order to operate such a reference electrode with conventional pH meters. This may have adverse effects on chemical stability. To counteract chemical attack by aggressive samples, or to increase the service life of the electrode according to the invention, a relatively high-ohm reference electrode with high-ohm treatment of the measurement and reference electrodes (two-channel impedance transformation) is preferred.

For example, pH meters, which operate with a one-channel impedance transformation, are often used in the laboratory and in operations, particularly for monitoring processes and for process control. With the use of an electrode according to the invention as the reference electrode, an impedance transformer for the reference electrode or for the reference and measurement electrode can be connected in series to the conventional pH or ion meter.

The electrode according to the invention may be combined in any construction with other electrodes, for example, in a concentric arrangement with a measurement electrode in the center, which is surrounded by a reference electrode according to the invention.

### BRIEF DESCRIPTION OF THE FIGURES

FIG. 1 shows a longitudinal section through a first example of an embodiment of an electrode according to the invention;

FIG. 2 shows a cross-section along line II-II in FIG. 1;

FIG. 3 shows an example of embodiment of a circuit for a measurement system with an electrode according to the invention;

FIG. 4 shows a longitudinal section through an example of an embodiment of a miniaturized electrode according to the invention; and

FIG. 5 shows a schematic longitudinal section through a miniaturized electrode according to the invention.

### DESCRIPTION OF THE PREFERRED EMBODIMENTS

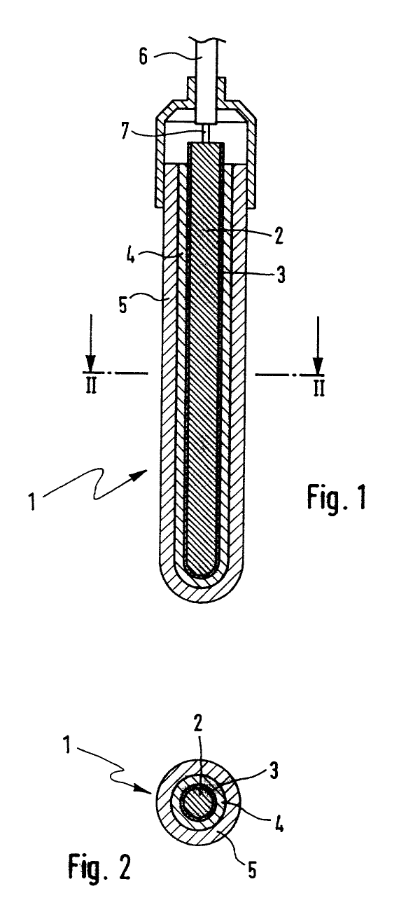

Referring now to the figures, FIG. 1 shows a first example of an embodiment of an electrode 1 comprising an electrode unit 2 in the form of a solid metal pin, for example, of silver, which is coated with a thin layer 3 of the salt of the metal of electrode unit 2, in this case, a chloride salt (silver chloride). Electrode unit 2 and layer 3 form a metal/metal salt interface. Of course, any other metal/metal salt or also metal/ion interface can be used.

Electrode unit 2, with layer 3 in this example of embodiment in FIG. 1, is surrounded by a compensation layer 4, which contains ions of layer 3, in this case of silver chloride. However, the layer may also be an electrolyte such as a 3-molar KCl solution, which serves as a reference electrolyte, in which case an electrode of the second type is then obtained. This may serve, for example, as the reference electrode of a pH measurement chain. Thus, high-alkaline media can also be measured. Compensation layer 4 may also be essentially comprised of polymers comprising ions dissolved in organic solvents.

Compensation layer 4 or aqueous solution thereof produces the connection from the bypass electrode (i.e., electrode unit 2 coated with layer 3) to the bridge substances and is thus the potential-determining electrolyte which establishes the reference potential.

The outermost layer forms a bridge substance 5 according to the invention. In this embodiment, the bridge substance comprises metal oxide ceramics, which are doped with a salt mixture. Casting ceramics were used in the example of the embodiment. A cross-section of this electrode showing the order of the various layers is shown in FIG. 2.

Bridge substance 5 was produced according to the following method. A ceramic powder containing approximately 20% by wt. of a salt mixture of potassium and sodium chloride in the ratio of approximately 2:1, as well as lithium chloride and sodium fluoride were mixed. The fraction of the lithium chloride and sodium fluoride salts amounted to approximately 5% by weight, each with respect to the potassium chloride/sodium chloride mixture. The 2:1 potassium chloride/sodium chloride mixture may also be viewed as a base mixture whose composition may be varied each time by a person skilled in the art according to the application of the bridge substance or the electrode produced therewith. The same is true for other salt admixtures. Care should be taken so that for the given temperature, the ion mobility of anions and cations is roughly comparable in the reference electrode and the transport numbers of anions and cations of the salt used are approximately equal.

A 2-molar aqueous solution of the salt mixture was applied. One liter of this aqueous solution was mixed with 4 kg of casting ceramics powder. This corresponds to a salt concentration of approximately 20% by weight. The resulting mixture was cast into a mold, pre-hardened for approximately 24 hours, and then hardened for 2 hours, first at 90° C. and then for 2 hours at 130° C.

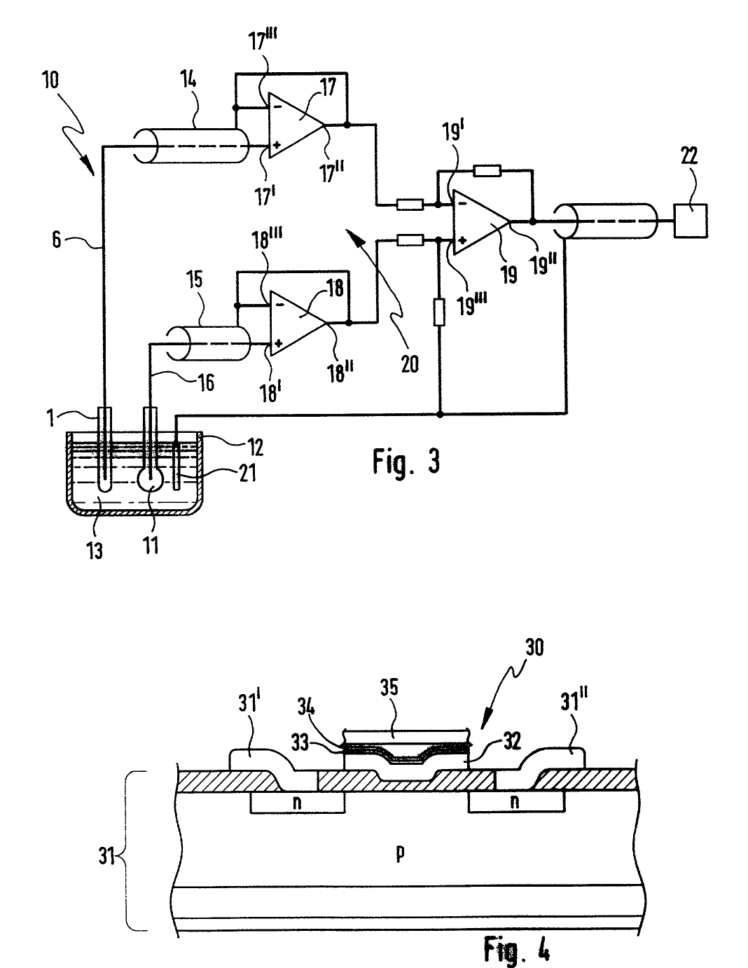

Electrodes of the present invention may be joined as the reference electrode of a two-bar measurement chain, as is shown in FIG. 3. Electrode 1 is joined with a corresponding measurement assembly 10 by means of coaxial cable 6 with inner conductors 7. Measurement assembly 10 has electrode 1 according to the invention as the reference electrode as well as a conventional measurement electrode 11. Electrodes 1, 11 are immersed in a container 12, which contains sample 13 to be measured.

A measurement electrode generally has a high membrane resistance. In the case of a glass electrode, this resistance can reach 1 GΩ. The ion meter or pH meter then has an input resistance of at least 1 TΩ. The signal emitted from an electrode or a sensor which is conducted, for example, to an operational amplifier, is thus denoted as the “high-ohm signal.” Such high-ohm signals, however, are extremely sensitive with respect to electrodynamic and electrostatic effects from the outside and tend to flow out as so-called “vagabond signals” (interferences). Thus electrodes and cables must be screened for protection from capacitive and inductive influences, so that such influences are deflected at the screen. Such screens 14, 15 are indicated in FIG. 3.

As shown in FIG. 3, the two high-ohm electrodes 1, 11 are each joined by a coaxial cable 6, 16 with a symmetric high-ohm input 17′, 18′, of an operational amplifier 17, 18. The output signal emitted at an output 17″, 18″ of each operational amplifier 17, 18 is guided, on the one hand, to a second input 17′″, 18′″ of operational amplifier 17, 18 as well as to screens 14, 15 of the respective electrode 1, 11. In this way, the capacity between the inner conductor of coaxial cables 6, 16 and screens 14, 15 is disconnected. On the other hand, the output signal is conducted to an input 19′, 19′″ of a third operational amplifier 19. This operational amplifier acts as a differential amplifier, i.e., a subtraction takes place between the reference and measurement signals. The three operational amplifiers thus form a two-channel impedance transformer 20. The output signal emitted at the low-ohm and capacitively loadable output 19″ of operational amplifier 19, which is led via a measurement-value transducer 22 to a suitable interface (for example, current interface, AD converter), thus represents the impedance-transformed potential difference of the two high-ohm electrodes 1, 11.

Measurement assembly 10 is grounded in that a metal contact is joined with sample 13. In the example of the embodiment, a contact pin 21 is immersed in sample 13. Contact pin 21 thus establishes the reference potential of the two high-ohm inputs 17′, 18′ of operational amplifier 17, 18. The electrochemical potential of the arbitrary (for example, metal) contact pin 21 has no effect on the measurement and thus finally falls out with the described subtraction.

An example of embodiment of a miniaturized electrode 30 is shown schematically in FIG. 4. Doping is designated by “p” and “n.” On a field-effect transistor, (in the example of the embodiment shown in FIG. 4, this is a self-blocking FET 31 with source 31′ and sink 31″), a thin silver plate 33, a silver chloride layer 34 and the bridge substance 35 already described above containing a polymer, which has ions dissolved in an organic solvent, are attached to gate 32.

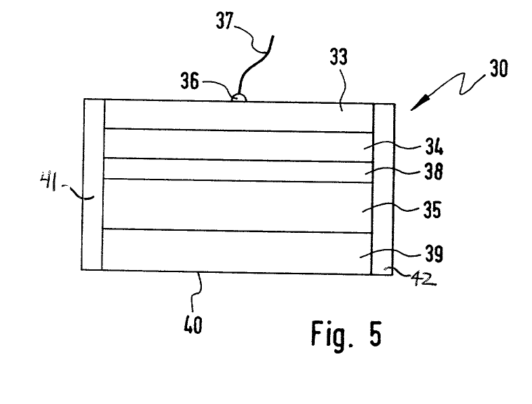

Such a miniaturized electrode 30 is shown, once more, enlarged and schematically in FIG. 5. The uppermost layer 33 is comprised of silver. It has an electrical contact 36, for example a solder contact, which produces the electrical connection to a cable 37, a circuit, a transistor or the like. The subsequent layer 34 is comprised of silver chloride. Then polymer layer 38 follows, for example, comprised of a polyester resin, which contains lithium chloride dissolved in methanol. This substance 34 represents the reference electrolyte of electrode 30. Then follows bridge substance 35 according to the invention. If electrode 30 is to be a reference electrode, precautions should be taken to ensure that the salts have an approximately equal anion and cation mobility and charge magnitude. For a configuration as an ion-selective electrode, the ion-selective material may already be integrated into bridge substance 35 so that the latter acts simultaneously as a sensor. Alternatively, an ion-selective sensor 39 can be provided also on the bridge substance. In all cases, underside 40 of electrode 30 produces the contact with the sample, whether this is bridge substance 35 or sensor 39. To this end, insulating components 41, 42 are introduced laterally on electrode 30.

The bridge substances and electrodes according to the invention that can thus be produced are suitable for applications in which conventional, state-of-the-art electrodes have previously failed. According to individual requirements, an electrode, which can be produced in sandwich form, can be constructed in accordance with the building-block principle.

### EQUIVALENTS

While the invention has been disclosed in connection to the preferred embodiments shown and described in detail, various modifications and improvements thereon will become readily apparent to those skilled in the art. Accordingly, the spirit and scope of the present invention is to be limited only by the following claims.

1. A bridge substance for an electrode comprising a solid, electrically conducting, chemically inert material, said material comprising a ceramic doped with one or more salts, glass doped with one or more salts, or a mixture thereof.

2. A bridge substance according to claim 1, wherein the salts have an approximately equal anion and cation mobility.

3. A bridge substance according to claim 1, wherein the salts have an approximately equal cation and anion charge magnitude.

4. A bridge substance according to claim 1, wherein the salt comprises potassium chloride.

5. A bridge substance according to claim 1, wherein the salt comprises a mixture of potassium and sodium chloride in a ratio of approximately 2:1.

6. A bridge substance according to claim 1, wherein the salt comprises an ion-sensitive material.

7. A bridge substance according to claim 1, wherein the salt comprises hygroscopic salts.

8. A bridge substance according to claim 1, wherein the salt concentration comprises approximately 5 to 30% by wt.

9. A bridge substance according to claim 1, wherein the ceramic comprises a metal oxide.

10. A bridge substance according to claim 1, wherein the ceramic comprises a casting ceramic or a powder ceramic.

11. A bridge substance according to claim 1, wherein the glass comprises a lead-cadmium glass.

12. A bridge substance according to claim 1, wherein the glass comprises actinides, lanthanides, or titanium in oxide form.

13. A bridge substance for an electrode comprising an electrically conducting, chemically inert material, said material comprising a polymer or mixture of polymers doped with one or more salts dissolved or suspended in an organic solvent.

14. A bridge substance according to claim 13 wherein the polymers or mixture of polymers comprise a duroplast or thermoplast.

15. A bridge substance according to claim 13 wherein the solvent comprises methanol, ethanol, or isopropanol.

16. A bridge substance according to claim 13 wherein the salt comprises lithium or tetraethylammonium chloride.

17. A bridge substance according to claim 13 wherein the material comprises cations and anions from salts whose overall charge magnitudes are approximately equal.

18. An electrode for measuring electrochemical values, comprising:
a) an electrode unit comprising a conducting intermediate layer;
b) a bridge substance comprising a solid, electrically conducting, chemically inert material, said material comprising a ceramic doped with one or more salts, glass doped with one or more salts, or a mixture thereof.

19. An electrode according to claim 18, wherein the salts have an approximately equal anion and cation mobility.

20. An electrode according to claim 18, wherein the salts have an approximately equal cation and anion charge magnitude.

21. An electrode according to claim 18, wherein the salt comprises potassium chloride.

22. An electrode according to claim 18, wherein the salt comprises a mixture of potassium and sodium chloride in a ratio of approximately 2:1.

23. An electrode according to claim 18, wherein the salt comprises an ion-sensitive material.

24. An electrode according to claim 18, wherein the salt comprises a hygroscopic salt.

25. An electrode according to claim 18, wherein the salt concentration is approximately 5 to 30% by wt.

26. An electrode according to claim 18, wherein the ceramic comprises a metal oxide.

27. An electrode according to claim 18, wherein the ceramic comprises a casting ceramic or a powder ceramic.

28. An electrode according to claim 18, wherein the glass comprises lead-cadmium glass.

29. An electrode according to claim 18, wherein the glass comprises oxides of titanium, actinides, or lanthanides.

30. An electrode according to claim 18, wherein the electrode unit comprises a metal substance.

31. An electrode according to claim 18, further comprising a layer in the form of a salt solution between the electrode unit and the bridge substance.

32. An electrode according to claim 31, wherein the layer comprises one or more polymers doped with one or more ions dissolved or suspended in an organic solvent.

33. An electrode according to claim 31, wherein the electrode unit is attached to the gate of a transistor and the bridge substance is attached to the electrode unit by means of the layer.

34. A measurement assembly for measuring electrochemical values comprising:
a) a potential-true screen; and
b) an electrode comprising (i) an electrode unit comprising a conducting intermediate layer, and (ii) a bridge substance comprising a solid, electrically conducting, chemically inert material comprising a ceramic doped with one or more salts, glass doped with one or more salts, or a mixture thereof.

35. A method for measuring electrochemical values in a sample comprising contacting the sample with at least one electrode in a one-bar or two-bar measurement chain, said electrode comprising
a) an electrode unit comprising a conducting intermediate layer; and
b) a bridge substance including a solid, electrically conducting, chemically inert material, said material comprising a ceramic doped with one or more salts, glass doped with one or more salts, or a mixture thereof.
